(19) United States
(12) Patent Application Publication
(10) Pub. No.: US 2010/0021600 A1
(43) Pub. Date: Jan. 28, 2010

(54) FLAVOR IMPROVING AGENT FOR FOOD AND BEVERAGE

(75) Inventors: Masayuki Yagi, Kyoto-shi (JP); Yuko Saito, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ARKRAY, INC., Kyoto-shi, Kyoto (JP)

(21) Appl. No.: 12/440,525

(22) PCT Filed: Apr. 23, 2008
(86) PCT No.: PCT/JP2008/057875

§ 371 Date: Mar. 9, 2009

(30) Foreign Application Priority Data
Apr. 25, 2007 (JP) 2007-115952

(51) Int. Cl. A23L 1/221; A23L 1/20; A23L 1/325; A23L 2/00; A23L 2/56

(52) U.S. Cl. 426/330.3; 426/651; 426/590; 426/655; 426/533; 426/321

(57) ABSTRACT

A flavor improving agent using material that has dietary history, i.e. material that has been eaten as food is provided, wherein the flavor improving agent suppresses peculiar smell of food and beverage. A composition containing extract from at least one plant selected from the group consisting of genus Crataegus of the family Rosaceae, genus Houttuynia of the family Saururaceae, genus Vitis of the family Vitaceae, genus Anthemis of the family Compositae, and genus Matricaria of the family Compositae is provided as the flavor improving agent for food and beverage. One of the extracts may be used alone or two or more of them may be used in combination. For example, a mixture of the extracts of the aforementioned four plants is preferable.

### TECHNICAL FIELD

The present invention relates to a flavor improving agent for food and beverage.

### BACKGROUND ART

In some cases, for example, food and beverage may have a peculiar smell from material, or a peculiar smell may be generated in processes of manufacturing, storing, cooking, etc. Since smell as well as taste and texture affects the flavor of food and beverage, a flavor improving agent is developed for food and beverage whose flavor has been damaged by smell. As the flavor improving agent, for example, an agent is known that suppresses smell of food and beverage by masking the smell thereof.

As for the flavor improving agent, the followings are reported. First, an aroma chemical is reported. When food and beverage is flavored by adding an aroma chemical, the smell damaging the flavor is masked, and the flavor of food and beverage can be improved. Examples of the aroma chemical include methyl anthranilate, acetophenone, butyl acetate, etc. Next, ethyl octanoate, ethyl decanoate, etc. are reported (Patent Documents 1 and 2). By adding them to food and beverage that gives off the peculiar smell containing collagen, collagen peptide, gelatin, various types of protein and decomposed substance thereof, etc. or has the deteriorated smell of oil, the smell can be reduced. Further, a composition containing trisaccharide and tetrasaccharide having a branched structure is reported (Patent Document 3). By adding this composition to food and beverage made of soy beans, the peculiar smell of soy protein is masked, and the flavor thereof can be improved.

However, many of these flavor improving agents are made of materials that have no dietary history, i.e., materials that have not been eaten as food, and safety is not supported by dietary history. Examples of manufacturing, in which materials having no dietary history are used in an industrial manufacturing, are as follows. The methyl anthranilate is synthesized by reacting anthranilic acid and methyl alcohol in the presence of sulfuric acid. Further, acetophenone is synthesized by reacting benzene and acetic anhydride or acethylene in the presence of aluminum chloride anhydrous, for example, and butyl acetate is synthesized by reacting acetic acid and butanol concentrated sulfuric acid, for example. Since the material that does not have dietary history is used, generally, purification is required and manufacturing process may be complicated. The masking effect of the aforementioned aroma chemical has an upper limit. Further, according to the nature of the aroma chemical, if the large amount of the aroma chemical is added, there is a possibility of damaging the flavor and quality of food and beverage. Moreover, if the flavor improving agent itself has a peculiar smell, depending on its additive amount, there is a possibility of damaging the flavor of food. Even when there is no problem in safety, those flavor improving agents usually are regarded not as food but as food additive.

[Patent Document 1] JP 2006-197856 A

[Patent Document 2] JP 2006-197857 A

[Patent Document 3] JP 2006-280310 A

### DISCLOSURE OF INVENTION

Hence, the present invention is intended to provide a flavor improving agent using materials that have dietary history, i.e., materials that have been eaten as food, wherein the flavor improving agent suppresses a peculiar smell of food and beverage.

In order to achieve the aforementioned object, a flavor improving agent for food and beverage of the present invention contains an extract from at least one plant selected from the group consisting of genus Crataegus of the family Rosaceae, genus Houttuynia of the family Saururaceae, genus Vitis of the family Vitaceae, genus Anthemis of the family Compositae, and genus Matricaria of the family Compositae.

According to the flavor improving agent of the present invention, for example, a peculiar smell of material of food and beverage, and smell generated in processes of manufacturing, processing, storing, etc. can be suppressed. Further, according to the flavor improving agent for food and beverage of the present invention, the aforementioned smell of food and beverage can be suppressed by masking, for example. In addition, generation of a smell component in the aforementioned processes can be suppressed by applying the flavor improving agent to the food and beverage in advance of each process. Specifically, for example, maillard reaction is inhibited and generation of a smell component due to the maillard reaction can be suppressed. Further, extracts contained in the flavor improving agent of the present invention are derived from plants (herb) that have dietary history and are familiar in dietary life. Therefore, safety of the flavor improving agent of the present invention is supported sufficiently and flavor of the food and beverage to which the flavor improving agent is added would not be damaged. Further, since preparation of the extract from each aforementioned herb is very simple, the flavor improving agent of the present invention is suitable for industrial manufacturing and can be manufactured at a low price.

### BRIEF DESCRIPTION OF DRAWINGS

FIG. 1 is a graph showing the relationship between a flavor improving agent concentration and a maillard reaction inhibition rate in Example 5 of the present invention.

FIG. 2 is a graph showing the relationship between a chamomile extract concentration and a maillard reaction inhibition rate in Example 6 of the present invention.

### BEST MODE FOR CARRYING OUT THE INVENTION

As described above, the flavor improving agent of the present invention is characterized by containing an extract from at least one plant selected from the group consisting of genus Crataegus of the family Rosaceae, genus Houttuynia of the family Saururaceae, genus Vitis of the family Vitaceae, genus Anthemis of the family Compositae, and genus Matricaria of the family Compositae. In the present invention, the flavor improving agent may contain an extract from only one of the plants or may contain extracts from two or more of the plants. As a specific example, the flavor improving agent of the present invention preferably contains a mixed extract from genus Crataegus of the family Rosaceae, genus Houttuynia of the family Saururaceae, genus Vitis of the family Vitaceae, and genus Anthemis of the family Compositae or genus Matricaria of the family Compositae.

As described above, since the flavor improving agent of the present invention contains an extract from at least one plant selected from the group consisting of genus Crataegus of the family Rosaceae, genus Houttuynia of the family Saururaceae, genus Vitis of the family Vitaceae, genus Anthemis of the family Compositae, and genus Matricaria of the family Compositae as an active ingredient, the flavor improving agent of the present invention is clearly excellent in safety.

In the present invention, examples of the plant of genus Crataegus of the family Rosaceae (Rosaceae Crataegus) include Midland hawthorn (Crataegus oxyacantha L.), hawthorn (C. cuneata Sieb. et Zucc.), etc. The extract from genus Crataegus of the family Rosaceae may be any extract from flower, flowering spike, fruit skin, fruit, stem, leaf, branch, branch with leaf, trunk, tree bark, rhizome, root bark, root, or seed. The extract may be an extract from one part of the plant or two or more parts of the plant. Further, the extract may be an extract from the whole plant body. As described above, the part of the plant to be extracted is not limited. For example, the extract may be an extract from fruit.

In the present invention, examples of the plant of genus Houttuynia of the family Saururaceae (Saururaceae Houttuynia) include dokudami (Houttuynia cordata Thunberg), etc. The extract from genus Houttuynia of the family Saururaceae may be any extract from flower, flowering spike, fruit skin, fruit, stem, leaf, rhizome, root bark, root, or seed. The extract may be an extract from one part of the plant or two or more parts of the plant. Further, the extract may be an extract from the whole plant body. As described above, the part of the plant to be extracted is not limited. For example, the extract may be an extract from aerial parts such as flower, flowering spike, fruit skin, fruit, stem, leaf, branch, branch with leaf, trunk, and tree bark.

In the present invention, examples of the plant of genus Vitis of the family Vitaceae (Vitaceae Vitis) include grape (Vitis vinifera L.), fox grape (Vitis labrusca L.), amazuru (V. saccharifera Makino), ehizuru (V. ficifolia Bunge var. lobata (Regel) Nakai), sankakuzuru (V. flexuosa Thunb.), crimson glory vine (V. coiguetiae Pulliat), hybrid grape of European grape and fox grape (V. labruscana Bailey), etc. The extract from genus Vitis of the family Vitaceae may be any extract from flower, flowering spike, fruit skin, fruit, stem, leaf, branch, branch with leaf, trunk, tree bark, rhizome, root bark, root, or seed. The extract may be an extract from one part of the plant or two or more parts of the plant. Further, the extract may be an extract from the whole plant body. As described above, the part of the plant to be extracted is not limited. For example, the extract may be an extract from leaf.

In the present invention, examples of the plant of genus Anthemis of the family Compositae (Compositae Anthemis (Chamaemelum)) include Roman chamomile (Anthemis nohilis L. (=Chamaemelum nobile)), etc. In the present invention, examples of the plant of genus Matricaria of the family Compositae (Compositae Matricaria) include German chamomile (Matricaria recutita L.), etc. The extract from genus Anthemis of the family Compositae or genus Matricaria of the family Compositae may be any extract from flower, flowering spike, fruit skin, fruit, stem, leaf, rhizome, root bark, root, or seed. The extract may be an extract from one part of the plant or two or more parts of the plant. Further, the extract may be an extract from the whole plant body. As described above, the part of the plant to be extracted is not limited. For example, the extract may be an extract from anthodium.

The extract of the present invention can be obtained, for example, from the aforementioned desired parts of the plant or from the whole plant body. An extracting method is not limited and examples thereof include a pressing method, a solvent extracting method, etc. An extracting solvent in the solvent extracting method is not limited and examples thereof include an aqueous solvent such as water, an organic solvent, etc. Examples of the organic solvent include lower alcohol such as ethanol, methanol, etc.; absolute ethanol; polyalcohol such as propylene glycol, 1,3-butylene glycol, etc.; ketone such as acetone, etc.; ester such as acetic acid ethyl ester; diethyl ether; dioxane; acetonitrile; xylene; benzene; chloroform; etc. The extracting solvent may be a mixture of the aqueous solvent and the organic solvent, and may be various alcohol aqueous solutions, for example. A specific example thereof includes ethanol aqueous solution. A ratio of the organic solvent in the mixture is, for example, in the range of 5 to 80% by volume. One of the solvents may be used alone or two or more of them may be used in combination.

In the extracting method, the desired part of the plant or the whole plant body, as a material, is soaked in the extracting solvent. The material directly may be soaked in the extracting solvent or may be soaked in the extracting solvent after pulverizing. When two materials are used, the extracting treatment may be applied to each material or may be applied to the mixture of two or more of the materials. When two or more materials are used, a ratio of the materials is not limited. For example, the materials may be added with equal amounts (weight). In a case where the aforementioned four plants are used, the extracting treatment preferably is applied to a mixed material in which each material is added with a dry weight ratio of 1:1:1:1.

A ratio between the material and the extracting solvent is not limited. For example, for 100 g of the material, the extracting solvent may be prepared in the range of 0.1 to 1000 L and preferably in the range of 1 to 100 L. The soaking time of the material in the extracting solvent is not limited and can be set suitably according to the type and amount of the plant, and the type and amount of the extracting solvent. For example, in a case where 100 g of the material is soaked in 10 L of the extracting solvent, the material is preferably soaked in the extracting solvent for 0.5 hour or more. More preferably, the material is soaked in the extracting solvent for 0.5 to 24 hours.

Conditions of the extraction are not limited. For example, when the extraction is carried out with aqueous solvent such as water, hot water extraction is preferable. Further, in advance of the hot water extraction, the material preferably is soaked in the aqueous solvent under the aforementioned conditions. Heating temperature of the hot water extraction is not limited, however is, for example, 30° C. or more, and preferably in the range of 50 to 100° C. Further, treating time of the hot water extraction can be set suitably according to the type and amount of the material to be treated, and the amount of the extracting solvent. For example, in a case where 100 g of the material is extracted with 10 L of the extracting solvent, the treatment time is preferably 0.5 hour or more, and more preferably 0.5 to 24 hours.

The extract thus-obtained may be used directly as the flavor improving agent or may be used as the flavor improving agent after a purifying treatment. The purifying treatment is not limited and examples thereof include a distilling treatment, a filtering treatment, a chromatography treatment, a drying treatment, etc.

The form of the extract in the present invention is not limited. For example, the form of the extract can be selected suitably according to the form of the flavor improving agent described later. Specific examples of the form include liquid, paste, emulsion, powder, etc. For example, concentrate and powder are preferable because they are easily processable according to the desired form of the flavor improving agent.

The flavor improving agent of the present invention is applicable as long as it contains the extract. For example, the flavor improving agent may contain the straight extract or a composition containing the extract and an appropriate diluting agent. The diluting agent is not limited and examples thereof include water, surfactant, glycerin, propylene glycol, alcohol (e.g., ethanol), oil and fat, sugar, polysaccharide (e.g., powder), gummy substance such as gum Arabic, polymer such as dextrin, etc. The flavor improving agent of the present invention can be prepared into the desired form, for example, by suitably using the diluting agent.

The form of the flavor improving agent of the present invention is not limited and can be decided suitably according to food and beverage to be applied with the present invention. Examples of the form of the flavor improving agent include liquid, paste, emulsion, gel, powder, granule, tablet, capsule, etc. In a case where the food and beverage to be treated with the present invention is liquid beverage or gel beverage, for example, the flavor improving agent may be added in the form of liquid, paste, emulsion, gel, etc., or in the form of granule, tablet, capsule, etc. to be dissolved or dispersed in the liquid beverage. In a case where food and beverage to be treated with the present invention is powder beverage or granule beverage, the flavor improving agent may be incorporated therein in the form of powder, granule, oil and fat mixture, emulsion, etc. In a case where food and beverage to be treated with the present invention is tablet beverage or capsule beverage, the flavor improving agent may be incorporated in the tablet or capsule. In a case where food and beverage to be treated with the present invention is food, the flavor improving agent may be incorporated therein in the aforementioned various forms, or the food may be coated or sprayed with the flavor improving agent of liquid, paste, emulsion, etc. Further, the food may be soaked in the flavor improving agent of the present invention of liquid, paste, emulsion, gel, etc.

A ratio of the extract in the flavor improving agent of the present invention is not limited. For example, in a case where the extract is powder, the extract can be used at the following ratio according to the way of application to the food and beverage. However, this is a mere example and the present invention is not limited thereby. In a case where food and beverage is coated or sprayed with the flavor improving agent of the present invention, a concentration of the powder extract in the liquid flavor improving agent is preferably in the range of 0.0001 to 99.9% (w/v). Further, in a case where food and beverage is soaked in the flavor improving agent of the present invention, a concentration of the powder extract in the liquid flavor improving agent is preferably in the range of 0.0001 to 80% (w/v). In a case where the flavor improving agent is incorporated into food and beverage, the powder extract preferably is incorporated such that an amount of the powder extract in the food and beverage is in the range of 0.00001 to 60% (w/v) per weight. From the dietary history of each herb, it is clear that the flavor improving agent of the present invention is excellent in safety. Therefore, even when the flavor improving agent of the present invention is applied to all sorts of food and beverage, an amount of intake thereof is not limited, for example.

The food and beverage to which the flavor improving agent of the present invention is added is not limited at all, and examples thereof include food and beverage itself, material of food and beverage, food and beverage that generates smell during processes of manufacturing, processing, storing, etc. The types of the smell are not limited. It may be a general bad smell, or a smell to be considered to be unpleasant in personal preference. In the present invention, a smell-generating mechanism is not limited. Further, a method of suppressing the smell is not limited at all. The generation itself may be suppressed, or the generated smell or smell of food and beverage and smell of material thereof may be masked. Examples of food and beverage are indicated below. However, the present invention is not limited thereto.

Examples of beverage include fruit beverage such as 100% fruit juice, fruit juice drink, juice with pulp, vegetable juice, tomato juice, drink containing fruit juice flavor, drink containing fruit juice at a low concentration, fruit beverage for dilution, etc.; carbonated beverage; beverage such as coffee, coffee drink, soft drink with coffee, cocoa, various teas, etc.; refreshing beverage such as vinegar drink, sports drink, etc.; milk; milk beverage; milk-based whey beverage; soy beverage such as soy milk, modified soy milk, etc.; lactic acid beverage; lactobacillus beverage; alcoholic beverage; nutritional beverage containing amino acid, etc.; functional beverage such as collagen drink, gelatin drink, etc.; nutritional beverage containing vitamin, mineral, etc.; etc.

The food to be treated with the present invention includes all sorts of food. Examples of the food include cereal, potato, sugar, confectionery, oil and fat, pulse, seafood, meat, egg, milk, vegetable, fruit, seaweed, seasoning, cooked and processed food, etc. Examples of the cooked and processed food include processed fishery product such as steamed fish paste, fish sausage, etc.; processed livestock product such as ham, sausage, etc.; confectionery such as cake, cookie, biscuit, snack, chocolate, etc.; noodle such as fresh noodle, Chinese noodle, boiled noodle, soba noodle, udon noodle, spaghetti, etc.; bread; fermented food such as miso, natto, etc.; pickle such as rice bran pickle, light pickle, etc.; canned product such as canned vegetable, canned fruit, canned fishery product, canned meat, etc.; dairy product such as cheese, butter, margarine, yogurt, etc.; frozen dessert such as ice cream, sherbet, ice, etc.; soy food such as tofu, bean curd refuse, etc.; prepared food; etc.

The flavor improving agent of the present invention can be applied not only to food and beverage having a general bad smell but also to food and beverage having a smell to be considered to be unpleasant in personal preference. An example of the latter food and beverage includes fermented food such as natto. It is known that the natto has the smell to be liked or disliked according to individuals, and natto is a typical food that has such smell. Further, from the nutritional value thereof, natto is considered as an excellent food. Therefore, conventionally, the development of natto with reduced smell has been studied so that those who dislike the smell thereof can eat it. Such reduction of the smell of natto is realized generally by changing manufacturing conditions such as a process of fermentation (for example, JPB3531070), and natto with reduced smell is sold in the market as a commercially-available product. However, in the market, since normal natto and natto with reduced smell are sold, those who dislike the smell thereof have to select not the normal natto but the natto with reduced smell. However, the smell of natto can be masked simply by adding the flavor improving agent of the present invention thereto. Therefore, there is no need to select the natto with reduced smell from various products. The flavor improving agent of the present invention is applicable not only to the fermented food such as natto, but also to the existing food and beverage according to individual preference. When the flavor improving agent of the present invention is applied, the food and beverage with the unpleasant smell can be ingested by avoiding the problem of the smell. In recent years, an unbalanced diet is acknowledged as a problem among people of all ages, and one of the reasons for that is peculiar smell of food and beverage. Examples of food and beverage having such smell include vegetable such as cucurbitaceous vegetable such as cucumber, etc., potherb such as celery, garlic, ginger, etc.; pickle; seafood; the aforementioned fermented food; etc. The smell of those food and beverage can be masked by coating, spraying, or incorporating the flavor improving agent of the present invention to the food and beverage. Further, the smell of those food and beverage also can be masked by soaking the food and beverage in the flavor improving agent. In this manner, even for food and beverage that hardly is ingested depending on individual preference in smell thereof, the smell can be masked and suppressed by the flavor improving agent of the present invention, for example. Therefore, a wider range of food and beverage can be ingested.

Further, specific examples of food and beverage are as follows. It is known that collagen, collagen peptide, gelatin, milk protein, milk peptide, soy protein, soy peptide, globin protein decomposed substance, or the like has peculiar smell and peculiar flavor (for example, JPA2006-197856, JPB2884244). Therefore, food and beverage containing them preferably are treated with the flavor improving agent of the present invention. Further, the flavor improving agent is applicable to food and beverage, in which the deteriorated smell of oil is generated (for example, JPA2006-197856).

The treatment timing of the flavor improving agent of the present invention to food and beverage is not particularly limited. The flavor improving agent of the present invention may be applied to food and beverage before ingestion, for example. Further, the flavor improving agent of the present invention also may be applied to food and beverage or material thereof in advance of processes of manufacturing, processing, storing, cooking, etc. The processes of manufacturing, processing, and cooking include, for example, a process of heating. The way of treatment is not limited and can be decided suitably according to forms of the food and beverage or material thereof. As described above, examples of the way of treatment include addition, incorporation, coating, spraying, soaking, etc.

As described above, in a case where the flavor improving agent of the present invention is applied to food and beverage before ingestion thereof, the smell derived from the food and beverage or the smell derived from the material of the food and beverage can be masked. For example, food and beverage subjected to heat treatment or food and beverage heated (cooked) before ingestion generates smell because of heating. This smell also can be masked by applying the flavor improving agent of the present invention to the food and beverage before ingestion. In contrast, in a case where the flavor improving agent of the present invention is applied to food and beverage or material thereof in advance of each process such as during the manufacturing process, not only the smell of the food and beverage or the smell of material thereof before applied with each process is masked but also generation of the smell in each process can be suppressed. Further, even in a case where the smell is generated in each process, they also can be masked. An example of generation of the smell includes a maillard reaction. For example, according to the present invention, the generation of the smell can be reduced by suppressing the maillard reaction generated between an amino compound and sugar. Suppression of the generation of smell is explained below with an example, however the present invention is not limited thereby.

In a case where food and beverage or material thereof include an amino compound and sugar, it is preferable that the flavor improving agent of the present invention is applied to the food and beverage or the material thereof in advance of a process of storing or a process including a heat treatment in which the maillard reaction is often generated. Thereby, for example, flavor of food and beverage can be improved or maintained by reducing the generation of the smell and further suppressing the smell. Examples of the amino compound include amino acid, polypeptide, protein, etc. The polypeptide includes denatured polypeptide and the protein includes denatured protein. The protein is not limited. Examples of the protein that has peculiar smell and can be a substrate for the maillard reaction include collagen, collagen peptide, gelatin, milk protein, milk peptide, soy protein, soy peptide, globin protein, globin protein decomposed substance, etc. Examples of the sugar include glucose, fructose, maltose, arabinose, xylose, galactose, lactose, invert sugar, reducing sugar such as isomerized sugar, sucrose, oligosaccharide, etc.

Examples of food and beverage to which the flavor improving agent of the present invention preferably is applied in advance of each process of manufacturing, processing, or storing are as follows. However, the present invention is not limited thereto. For example, commercially available beverage, canned product, and retort food are provided in a container and they normally are subjected to a sterilization treatment by heating. Further, since these food and beverage generally contain an amino compound and sugar, it is considered that the maillard reaction may be generated in the processes of manufacturing, processing, storing, etc. Therefore, it is preferable that the flavor improving agent of the present invention is added to the food and beverage applied with the heat treatment or preliminarily added to the food and beverage in advance of the heat treatment. Seafood such as fish has a peculiar smell and a cooking smell is further generated by grilling it. With respect to such food, the peculiar smell of the fish and the cooking smell thereof can be masked, for example, by applying the flavor improving agent of the present invention after cooking. Further, when the seafood is cooked after treatment with the flavor improving agent of the present invention (e.g., coating, spraying, soaking, etc.), for example, generation of the cooking smell can be suppressed and the peculiar smell, which the fish originally has, can be masked. Since the generation of the smell because of the heat treatment can be suppressed in this manner, for example, spreading of the smell to cooking utensil and kitchen can be prevented.

It is also preferable that the flavor improving agent of the present invention is applied to food and beverage that generates deteriorated smell by storing, for example.

In this manner, according to the flavor improving agent of the present invention, for example, the peculiar smell of the food and beverage or the smell generated in each process can be masked or the generation of the smell in each process can be suppressed. Therefore, according to the flavor improving agent of the present invention, the flavor of the food and beverage can be improved or maintained.

Next, a method of improving flavor of the present invention is a method of improving the flavor of food and beverage. The method is characterized by including a process in which the flavor improving agent of the present invention is brought into contact with the food and beverage or the material thereof. The present invention is characterized by using the flavor improving agent of the present invention, and other processes and conditions are not limited.

In the present invention, a method of contacting the flavor improving agent relative to the food and beverage or the material thereof is not limited at all. As described above, for example, the flavor improving agent may be applied to the food and beverage by coating, spraying, or incorporating. Further, the food and beverage may be soaked in the flavor improving agent.

An inhibitor of the present invention is an inhibitor of the maillard reaction. The inhibitor is characterized by containing an extract of at least one plant selecting from the group consisting of genus Crataegus of the family Rosaceae, genus Houttuynia of the family Saururaceae, genus Vitis of the family Vitaceae, genus Anthemis of the family Compositae, and genus Matricaria of the family Compositae. As for the extract of the inhibitor, the same extract of the flavor improving agent of the present invention can be used. Since the inhibitor of the present invention inhibits the maillard reaction, the generation of the smell because of the maillard reaction can be prevented. As a result, the flavor of the food can be maintained.

A method of inhibiting of the present invention is a method of inhibiting the maillard reaction. The method is characterized by bringing the inhibitor of the present invention in contact with the substrate for the maillard reaction.

The substrate for the maillard reaction to which the inhibitor of the present invention is applied is not particularly limited. However, it is preferable that the substrate for the maillard reaction is food. Examples of the food are not particularly limited and an example thereof includes the food and beverage or the material thereof that contains an amino compound and sugar therein. A method of using it is not particularly limited and is same as that of the flavor improving agent and the method of improving flavor of the present invention.

Next, Examples of the present invention are described. However, the present invention is not limited by the following Examples.

### Example 1

The flavor improving agent of the present invention was added to collagen beverage, and suppression of the change in flavor due to heat and storage was confirmed.

### Preparation of Flavor Improving Agent

Dry materials of Roman chamomile (anthodium), dokudami (aerial part), Midland hawthorn (fruit), and grape (leaf) are mixed such that each material has an equal amount (weight). This dry mixture (100 g) was soaked in purified water (10 L) at about 80° C. for about 5 hours. Thereby, a plant extract of the dry mixture was extracted. This extract was filtrated to remove residue and filtrate (about 10 kg) was collected. The filtrate further was dried to remove solvent (purified water) and 20 g of powder substance was obtained. The powder substance was mixed with diluting agents (dextrin, starch, calcium stearate, silicon dioxide, caramel pigment, titanium dioxide, soy-derived lecithin) and a solid flavor improving agent was obtained.

### Preparation of Collagen Beverage

Collagen beverage was prepared by dissolving 3 g of porcine-derived collagen (trade name: collagen, manufactured by Hanamai Inc.), 5 g of sucrose, 5 g of fructose, and 0.1 g of citric acid in 100 mL of water.

### Confirmation of Change in Flavor

### (1) Addition of Flavor Improving Agent Before Heating

The flavor improving agent was added to the collagen beverage such that a concentration of the flavor improving agent becomes a predetermined concentration (0.05% (w/v), 0.1% (w/v)). This collagen beverage was referred to as Example 1-1. Further, a collagen beverage to which the flavor improving agent was not added was referred to as Comparative Example 1-1. These collagen beverages were applied with a thermal sterilization at 110° C. for 5 minutes. After the thermal sterilization, each collagen beverage was cooled to room temperature and the flavor thereof was confirmed. As shown below, the flavor of the collagen beverage of Example 1-1 was evaluated by comparing with the collagen beverage of Comparative Example 1-1 (control).

### (2) Addition of Flavor Improving Agent After Heating

The collagen beverage was subjected to a thermal sterilization at 110° C. for 5 minutes. Then, the collagen beverage was cooled to room temperature. Thereafter, the flavor improving agent was added to the collagen beverage such that a concentration of the flavor improving agent becomes a predetermined concentration (0.05% (w/v), 0.1% (w/v)). This collagen beverage was referred to as Example 1-2 and the flavor thereof was confirmed after adding the flavor improving agent. Further, the collagen beverage to which the flavor improving agent was not added after the thermal sterilization was referred to as Comparative Example 1-2 and the flavor thereof was confirmed in the same manner as Example 1-2. As shown below, the flavor of the collagen beverage of Example 1-2 was evaluated by comparing with the collagen beverage of Comparative Example 1-2 (control).

### (3) Addition of Flavor Improving Agent Before Heating+Change in Flavor Over Time

The flavor improving agent was added to the collagen beverage such that a concentration of the flavor improving agent becomes a predetermined concentration (0.1% (w/v)). This collagen beverage was referred to as Example 1-3. Further, a collagen beverage to which the flavor improving agent was not added was referred to as Comparative Example 1-3. These collagen beverages were subjected to a thermal sterilization at 110° C. for 5 minutes. After the thermal sterilization, each collagen beverage was cooled to room temperature and the flavor thereof was confirmed. Further, these collagen beverages were stored at 35° C., and the flavor thereof after 30 days and 60 days were confirmed. As shown below, the flavor of the collagen beverage of Example 1-3 was evaluated by comparing with the collagen beverage of Comparative Example 1-3 (stored 0 day, control) which was subjected to the thermal sterilization and then cooled to room temperature.

### Method of Evaluating Flavor

The flavor of the collagen beverage was evaluated by comparing with the control collagen beverage after the thermal sterilization in accordance with the following evaluation criteria. Evaluation results of five evaluators were averaged and the thus-obtained evaluation results are shown as follows. Generally, the collagen smell is a distinctive smell like glue. Further, the deteriorated smell is a smell, in which collagen is deteriorated, and a smell to which the deteriorated smell by an oxidation of other components is added.
+2: very good as compared to the control
+1: good as compared to the control
0: same as the control
−1: slightly bad as compared to the control
−2: very bad as compared to the control

TABLE 1

| | Comparative Example 1-1 | Example 1-1 | |
|---|---|---|---|
| Collagen | Flavor improving agent | Flavor improving agent | Flavor improving agent |
| beverage | 0% | 0.05% | 0.1% |
| Add before | 0 | 1.4 | 2.0 |
| heating | Collagen smell/ | Very little collagen smell/ | Extremely little collagen |
| | deteriorated smell | deteriorated smell | smell/deteriorated smell |
| | | Fairly good flavor | Very good flavor |

TABLE 2

| | Comparative Example 1-2 | Example 1-2 | |
|---|---|---|---|
| Collagen | Flavor improving agent | Flavor improving agent | Flavor improving agent |
| beverage | 0% | 0.05% | 0.1% |
| Add after | 0 | 0.8 | 1.4 |
| heating | Collagen smell/ | Little collagen smell/ | Very little collagen smell/ |
| | deteriorated smell | deteriorated smell | deteriorated smell |
| | | Good flavor | Fairly good flavor |

TABLE 3

| | Comparative Example 1-3 | Example 1-3 |
|---|---|---|
| Collagen | Flavor improving agent | Flavor improving agent |
| beverage | 0% | 0.1% |
| Right after | 0 | 2.0 |
| heating | Collagen smell/ | Extremely little collagen |
| | deteriorated smell | smell/deteriorated smell |
| | | Very good flavor |
| After 30 days | −1.0 | 1.4 |
| | Worse than right | Very little collagen smell/ |
| | after heating | deteriorated smell |
| | | Fairly good flavor |
| After 60 days | −2.0 | 0.6 |
| | Worse than | Little collagen smell/ |
| | after 30 days | deteriorated smell |
| | | Good flavor |

As shown in Table 1, with respect to Example 1-1 in which the flavor improving agent was added to the collagen beverage in advance of the heat treatment, as compared to Comparative Example 1-1 in which the flavor improving agent was not added, the generation of the collagen smell and deteriorated smell was suppressed and the flavor was improved. Further, as shown in Table 2, with respect to Example 1-2 in which the flavor improving agent was added to the collagen beverage after the heat treatment, as compared to Comparative Example 1-2 in which the flavor improving agent was not added, the collagen smell and the deteriorated smell were removed and the flavor was improved. Moreover, as shown in Table 3, with respect to Example 1-3 in which the flavor improving agent was added to the collagen beverage in advance of the heat treatment, as compared to Comparative Example 1-3 in which the flavor improving agent was not added, problems of the collagen smell and deteriorated smell were suppressed even when the collagen beverage was stored for 30 days and 60 days, and the good flavor was maintained for a long period of time.

### Example 2

The flavor improving agent of the present invention was added to fish, and the flavor of fish was confirmed. The flavor improving agent prepared in Example 1 was used as the flavor improving agent in Example 2.

### Confirmation of Change in Flavor

### (1) Soaked in Flavor Improving Agent Before Heating

A flavor improving agent solution was prepared by dissolving the flavor improving agent in water such that a concentration of the flavor improving agent becomes 1% (w/v). Shishamo (Spirinchus lanceolatus, dry) and Japanese anchovy (Engraulis japonica, raw) respectively were soaked in the flavor improving agent solution at room temperature of 20° C. for 10 minutes. After soaking, the fishes were drained and grilled for 10 minutes. The thus-obtained fishes were referred to as Example 2-1. Further, fishes soaked in water instead of the flavor improving agent solution were grilled in the same manner. The thus-obtained fishes were referred to as Comparative Example 2-1. The flavor of these fishes was confirmed. As shown below, each flavor of the shishamo (Spirinchus lanceolatus, dry) and the Japanese anchovy (Engraulis japonica, raw) of Example 2-1 was evaluated by comparing with Comparative Example 2-1 (control).

(2) Coated with Flavor Improving Agent After Heating

Shishamo (Spirinchus lanceolatus, dry) and Japanese anchovy (Engraulis japonica, raw) were grilled for 10 minutes. After cooking, each surface (whole surface) of the fishes was coated with the flavor improving agent solution. The thus-obtained fishes were referred to as Example 2-2 and the flavor thereof was confirmed. Further, after cooking, each surface (whole surface) of the fishes was coated with water instead of the flavor improving agent solution. The thus-obtained fishes were referred to as Comparative Example 2-2 and the flavor thereof was confirmed in the same manner. As shown below, each flavor of the shishamo (Spirinchus lanceolatus, dry) and the Japanese anchovy (Engraulis japonica, raw) of Example 2-2 was evaluated by comparing with Comparative Example 2-2 (control).

### Method of Evaluating Flavor

Each flavor of the fishes after cooking was evaluated by comparing with the control (shishamo (Spirinchus lanceolatus) and Japanese anchovy (Engraulis japonica)), to which the flavor improving agent was not applied, in accordance with the following evaluation criteria. Evaluation results of five evaluators were averaged and the thus-obtained evaluation results are shown as follows.
+2: very good as compared to the control
+1: good as compared to the control
0: same as the control
−1: slightly bad as compared to the control
−2: very bad as compared to the control

TABLE 4

| | Comparative Example 2-1 | Example 2-1 |
|---|---|---|
| Soak before | Flavor improving agent | Flavor improving agent |
| heating | 0% | 1% |
| Shishamo | 0 | 1.8 |
| (Spirinchus | Strong fishy smell/ | Very little fishy smell/ |
| lanceolatus, Dry) | grilled smell of fish | grilled smell of fish |
| | | Good flavor |
| Japanese anchovy | 0 | 1.9 |
| (Engraulis | Strong fishy smell/ | Very little fishy smell/ |
| japonica, Raw) | grilled smell of fish | grilled smell of fish |
| | | Good flavor |

TABLE 5

| | Comparative Example 2-2 | Example 2-2 |
|---|---|---|
| Coat after | Flavor improving agent | Flavor improving agent |
| heating | 0% | 1% |
| Shishamo | 0 | 1.1 |
| (Spirinchus | Strong fishy smell/ | Acceptable fishy smell/ |
| lanceolatus, Dry) | grilled smell of fish | grilled smell of fish |
| | | Good flavor |
| Japanese anchovy | 0 | 1.2 |
| (Engraulis | Strong fishy smell/ | Acceptable fishy smell/ |
| japonica, Raw) | grilled smell of fish | grilled smell of fish |
| | | Good flavor |

As shown in Table 4, with respect to Example 2-1 in which the fishes were soaked in the flavor improving agent solution in advance of the heat treatment, as compared to Comparative Example 2-1 in which the fishes were not soaked in the flavor improving agent solution, the fishy smell was removed, generation of fishy smell in grilling was suppressed, and the flavor was improved. Further, as shown in Table 5, with respect to Example 2-2 in which the cooked fishes were coated with the flavor improving agent solution after the heat treatment, as compared to Comparative Example 2-2 in which the cooked fishes were not coated with the flavor improving agent solution, the fishy smell and the grilled smell of fish were removed and the flavor was improved.

### Example 3

The flavor improving agent of the present invention was added to rice bran pickle, and the flavor of rice bran pickle was confirmed. The flavor improving agent prepared in Example 1 was used as the flavor improving agent in Example 3.

### Confirmation of Change in Flavor

### (1) Addition of Flavor Improving Agent to Rice Bran Bed

The flavor improving agent was incorporated into a rice bran bed such that a concentration of the flavor improving agent becomes 1% (w/v). Cucumber was pickled in the rice bran bed at 10° C. for 7 days. Thereafter, cucumber was picked up from the rice bran bed and the flavor of the rice bran pickle was confirmed after washing it with water. The thus obtained rice bran pickle was referred to as Example 3-1. Further, cucumber was pickled in the rice bran bed, to which the flavor improving agent was not incorporated, and the flavor of the rice bran pickle was confirmed in the same manner. The thus-obtained rice bran pickle was referred to as Comparative Example 3-1. As shown below, the flavor of the rice bran pickle of Example 3-1 was evaluated by comparing with the rice bran pickle of Comparative Example 3-1 (control).

### (2) Soaked in Flavor Improving Agent After Pickling

Cucumber was pickled in a rice bran bed, to which the flavor improving agent was not incorporated, at 10° C. for 7 days. Thereafter, cucumber was picked up from the rice bran bed and soaked in the flavor improving agent solution of Example 2 (1% (w/v)) at 20° C. for 10 minutes. Thereafter, the flavor of the rice bran pickle was confirmed. The thus-obtained rice bran pickle was referred to as Example 3-2. Further, cucumber picked up from the rice bran bed was soaked in water under the same conditions, and the flavor of the rice bran pickle was confirmed. The thus-obtained rice bran pickle was referred to as Comparative Example 3-2. As shown below, the flavor of the rice bran pickle of Example 3-2 was evaluated by comparing with the rice bran pickle of Comparative Example 3-2 (control).

### Method of Evaluating Flavor

The flavor of the rice bran pickle of cucumber was evaluated by comparing with the control, to which the flavor improving agent was not applied, in accordance with the following evaluation criteria. Evaluation results of five evaluators were averaged and the thus-obtained evaluation results are shown as follows.
+2: very good as compared to the control
+1: good as compared to the control
0: same as the control
−1: slightly bad as compared to the control
−2: very bad as compared to the control

TABLE 6

| | Comparative Example 3-1 | Example 3-1 |
|---|---|---|
| Rice bran pickle | Flavor improving agent | Flavor improving agent |
| of cucumber | 0% | 1% |
| Add to rice | 0 | 1.6 |
| bran bed | Strong peculiar smell of | Very little peculiar smell of |
| | pickle and cucumber | pickle and cucumber |
| | | Good flavor |

TABLE 7

| | Comparative Example 3-2 | Example 3-2 |
|---|---|---|
| Rice bran pickle | Flavor improving agent | Flavor improving agent |
| of cucumber | 0% | 1% |
| Soak after | 0 | 1.2 |
| pickling | Strong peculiar smell of | Acceptable peculiar smell of |
| | pickle and cucumber | pickle and cucumber |
| | | Good flavor |

As shown in Table 6, with respect to Example 3-1 in which the flavor improving agent was incorporated into the rice bran bed before pickling, as 5 compared to Comparative Example 3-1 in which the flavor improving agent was not incorporated into the rice bran bed, the peculiar smell of pickle and cucumber were reduced and the flavor of the rice bran pickle was improved. Further, as shown in Table 7, with respect to Example 3-2 in which the cucumber soaked in the rice bran bed was further soaked in the flavor improving agent solution, as compared to Comparative Example 3-2 in which the cucumber soaked in the rice bran bed was not soaked in the flavor improving agent solution, the peculiar smell of pickle and cucumber were suppressed and the flavor of the rice bran pickle was improved.

### Example 4

The flavor improving agent of the present invention was added to natto, and the flavor of natto was confirmed. The flavor improving agent prepared in Example 2 was used as the flavor improving agent in Example 4.

### Confirmation of Change in Flavor

0.2 g of the flavor improving agent was added to 20 g of commercially available natto such that a concentration of the flavor improving agent becomes about 1% (w/v), and then mixed. The thus obtained natto was referred to as Example 4 and the flavor thereof was confirmed. Further, a commercially available natto to which the flavor improving agent solution was not added was referred to as Comparative Example 4 and the flavor thereof was confirmed in the same manner. As shown below, the flavor of the natto of Example 4 was evaluated by comparing with Comparative Example 4 (control).

### Method of Evaluating Flavor

The flavor of the natto was evaluated by comparing with the control, to which the flavor improving agent was not applied, in accordance with the following evaluation criteria. Evaluation results of five evaluators were averaged and the thus-obtained evaluation results are shown as follows.
+2: very good as compared to the control
+1: good as compared to the control
0: same as the control
−1: slightly bad as compared to the control
−2: very bad as compared to the control

TABLE 8

| | Comparative Example 4 | Example 4 |
|---|---|---|
| | Flavor improving agent | Flavor improving agent |
| | 0% | 1% |
| natto | 0 | 1.8 |
| | Strong peculiar smell of | No peculiar smell of natto |
| | natto | Eater-friendly flavor |

As shown in Table 8, with respect to Example 4 in which the flavor improving agent was added to natto, as compared to Comparative Example 4 in which the flavor improving agent was not added to natto, the peculiar smell of natto was suppressed.

### Example 5

With respect to the flavor improving agent of the present invention, an inhibitory effect on a maillard reaction was confirmed.

2 mL of collagen aqueous solution (40 mg/mL), 1 mL of glucose aqueous solution (2 mol/L), 5 mL of phosphate buffer solution (pH7.4, 100 mmol/L), and 1 mL of distilled water were mixed. As for the collagen, porcine-derived collagen (trade name: collagen, manufactured by Hanamai Inc.), fish collagen (trade name: fish collagen, manufactured by YMC Ingrid), fish-derived collagen peptide (trade name: collagen peptide F-500, manufactured by YASU CHEMICAL INC.) were used, respectively. Relative to 9 mL of this mixture, 1 mL of flavor improving agent solution, in which the flavor improving agent of Example 1 was dissolved in water such that a concentration of the flavor improving agent becomes in the range of 0.025 to 2.5% (w/v), was added and incubated at 60° C. for 40 hours. The concentration of the flavor improving agent in this reaction solution was 0.0025, 0.025, and 0.25% (w/v). Thereafter, the produced amount of the maillard reaction of this reaction solution was measured as fluorescence intensity. With respect to the measurement wave length, an exciting wave length was 370 nm and a fluorescence wavelength was 440 nm. As a control, 1 mL of water instead of 1 mL of the flavor improving agent solution was added to 9 mL of the mixture and incubated in the same manner. Thereafter, the fluorescence intensity was measured. Then, a maillard reaction inhibition rate of the flavor improving agent was calculated by the following formula.

maillard reaction inhibition rate (%)=100×(C−E)/C
C: fluorescence intensity of control
E: fluorescence intensity of Example

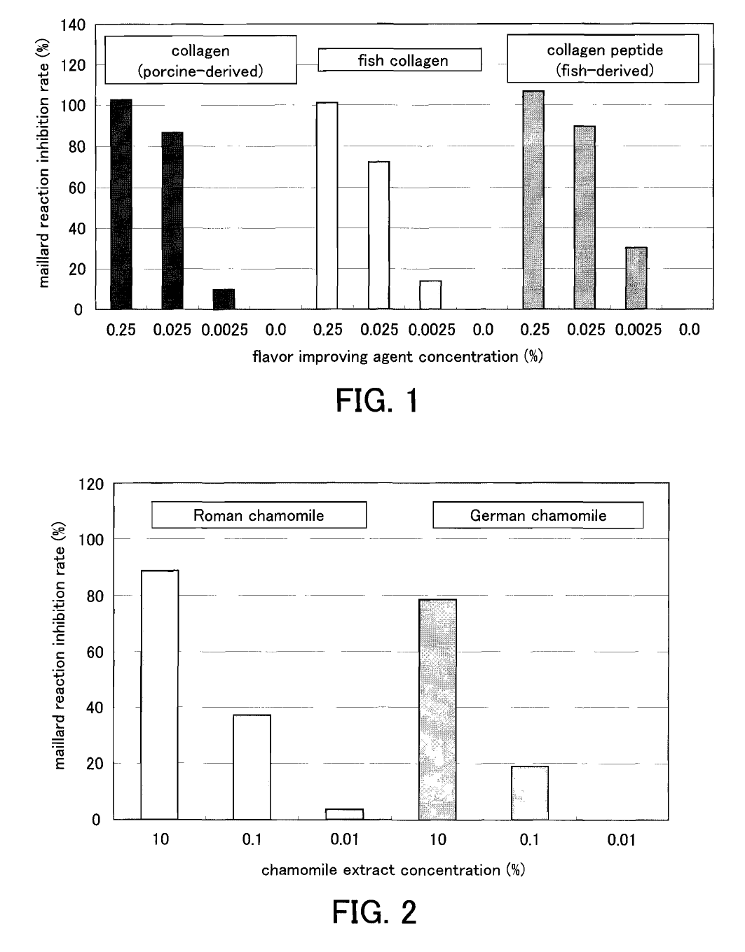

Results thereof are shown in FIG. 1. FIG. 1 shows graphs indicating the relationship between a concentration of the flavor improving agent and a rate of the maillard reaction inhibition in the reaction solution. As shown in FIG. 1, it was confirmed that the flavor improving agent of this Example has a maillard reaction inhibitory capacity.

### Example 6

With respect to the flavor improving agent of the present invention (chamomile extract), a inhibitory effect of maillard reaction was confirmed.

1.5 g of dry Roman chamomile (anthodium) dust or 1.5 g of dry German chamomile (anthodium) dust were added in 150 mL of hot water (90° C.) and left at rest for 15 minutes. Thereafter, the solution was filtrated and each chamomile extract was obtained.

2 mL of collagen aqueous solution (40 mg/mL), 1 mL of glucose aqueous solution (2 mol/L), 5 mL of phosphate buffer solution (pH7.4, 100 mmol/L), and 1 mL of distilled water were mixed. As for the collagen, porcine-derived collagen (trade name: collagen, manufactured by Hanamai Inc.) was used. Relative to 9 mL of this mixture, 1 mL of the Roman chamomile extract or 1 mL of German chamomile extract was added and incubated at 60° C. for 40 hours. Thereafter, the produced amount of the maillard reaction of this reaction solution was measured in the same manner as Example 5 and a rate of the maillard reaction inhibition was calculated. As for the control, the measurement was carried out in the same manner as Example 5 except that 1 mL of water instead of 1 mL of chamomile extract was added to the 9 mL of the mixture.

These results are shown in FIG. 2. FIG. 2 shows graphs indicating the relationship between a concentration of the chamomile extract and a rate of the maillard reaction inhibition. As shown in FIG. 2, it was confirmed that the Roman chamomile extract and the German chamomile extract have nearly equal inhibitory effect of maillard reaction.

### INDUSTRIAL APPLICABILITY

As described above, according to the flavor improving agent of the present invention, for example, the peculiar smell of material of food and beverage, and smell generated in processes of manufacturing, processing, storing, etc. can be suppressed. Further, according to the flavor improving agent for food and beverage of the present invention, the aforementioned smell of food and beverage can be suppressed by masking, for example. In addition, the maillard reaction in each process can be inhibited and generation of smell component due to the maillard reaction can be suppressed by applying the flavor improving agent to the food and beverage in advance of the process of heating or storing. Moreover, the smell generated regardless of the maillard reaction and the aforementioned peculiar smell of material of food and beverage also can be suppressed by masking, for example. Extracts contained in the flavor improving agent of the present invention are derived from plants (herb) that have dietary history and are familiar in dietary life. Therefore, safety of the flavor improving agent of the present invention is sufficiently supported and the flavor of the food and beverage to which the flavor improving agent is added would not be damaged. Further, since preparation of the extract from the aforementioned each herb is very simple, the flavor improving agent of the present invention is suitable for industrial manufacturing and can be manufactured at a low price.

1. A flavor improving agent for food and beverage, wherein the flavor improving agent contains an extract from at least one plant selected from the group consisting of genus Crataegus of the family Rosaceae, genus Houttuynia of the family Saururaceae, genus Vitis of the family Vitaceae, genus Anthemis of the family Compositae, and genus Matricaria of the family Compositae.

2. The flavor improving agent according to claim 1, wherein a plant of genus Crataegus of the family Rosaceae is Midland hawthorn, a plant of genus Houttuynia of the family Saururaceae is dokudami, a plant of genus Vitis of the family Vitaceae is grape, a plant of genus Anthemis of the family Compositae is Roman chamomile, and a plant of genus Matricaria of the family Compositae is German chamomile.

3. The flavor improving agent according to claim 1, wherein the flavor improving agent contains a mixed extract from a plant of genus Crataegus of the family Rosaceae, a plant of genus Houttuynia of the family Saururaceae, a plant of genus Vitis of the family Vitaceae, and a plant of genus Anthemis of the family Compositae or a plant of genus Matricaria of the family Compositae.

4. The flavor improving agent according to claim 1, wherein the extract is at least one of a hot water extract and an organic solvent extract.

5. The flavor improving agent according to claim 1, wherein the food and beverage is food containing at least one amino compound selected from the group consisting of amino acid, polypeptide, and protein.

6. The flavor improving agent according to claim 5, wherein the amino compound is at least one selected from the group consisting of collagen, collagen peptide, gelatin, soy protein, soy peptide, milk protein, and milk peptide.

7. The flavor improving agent according to claim 1, wherein the food and beverage is food and beverage containing sugar.

8. The flavor improving agent according to claim 1, wherein the food and beverage is heated or stored food and beverage, or food and beverage before heating or storing.

9. The flavor improving agent according to claim 1, wherein the food and beverage is fermented food, pickle, or seafood.

10. A method of improving flavor of food and beverage, wherein the method comprises a process in which a flavor improving agent according to claim 1 is brought into contact with the food and beverage or material thereof.

11. An inhibitor of a maillard reaction, wherein the inhibitor contains an extract from at least one plant selected from the group consisting of genus Crataegus of the family Rosaceae, genus Houttuynia of the family Saururaceae, genus Vitis of the family Vitaceae, genus Anthemis of the family Compositae, and genus Matricaria of the family Compositae.

12. The inhibitor according to claim 11, wherein the inhibitor inhibits the maillard reaction in food and beverage or material thereof.

13. A method of inhibiting a maillard reaction, wherein the method comprises a process in which an inhibitor according to claim 11 is brought into contact with a substrate for the maillard reaction.

14. The method of inhibiting according to claim 13, wherein the substrate is a substrate contained in food and beverage or material thereof.

15. The method of inhibiting according to claim 13, wherein the substrate is an amino compound and sugar.
